(19) United States
(12) Patent Application Publication
(10) Pub. No.: US 2008/0141590 A1
(43) Pub. Date: Jun. 19, 2008

(54) Method and apparatus for vaporizing fuel for a catalytic hydrocarbon fuel reformer

(76) Inventors: Karl J. Haltiner, Fairport, NY (US); Malcolm James Grieve, Fairport, NY (US)

Correspondence Address: DELPHI TECHNOLOGIES, INC., M/C 480-410-202, PO BOX 5052, TROY, MI, 48007, US

(21) Appl. No.: 11/588,731

(22) Filed: Oct. 27, 2006

(51) Int. Cl. B01J 7/00; H01M 8/06; C10J 3/46

(52) U.S. Cl. 48/197 R; 48/61

(57) ABSTRACT

A catalytic reformer assembly is used to generate reformate from hydrocarbon fuels for fueling an energy producing source such as a solid oxide fuel cell (SOFC) assembly or an internal combustion engine (ICE). In the case of an SOFC assembly, it emits a tail gas (syngas) from the anodes which contains significant residual hydrogen and carbon monoxide, is very hot, and is completely anoxic. Syngas is thus an ideal medium for vaporizing and carrying higher boiling point fuels into the reformer. At least a portion of the anode syngas is recycled into a fuel vaporizer/mixer ahead of the reformer and ahead of the entry point of air into the fuel stream, such that the fuel dispersed into the fuel vaporizer/mixer is fully vaporized and heated prior to being combined with air for exothermic reforming. In the case of an ICE, hot exhaust is used as the recycled carrier gas.

This invention was made with United States Government support under Government Contract/Purchase Order No. DE-FC26-02NT41246. The Government has certain rights in this invention.

### TECHNICAL FIELD

The present invention relates to a catalytic hydrocarbon reformer for converting a hydrocarbon stream to a gaseous reformate fuel stream comprising hydrogen; more particularly, to means for vaporization of liquid hydrocarbon fuel for such a reformer; and most particularly to a method and apparatus for rapid heating and vaporization of a liquid hydrocarbon fuel stream by mixing the fuel ahead of the reformer with hot anode tail gas recycled from an associated solid oxide fuel cell stack being supplied with reformate from the reformer.

### BACKGROUND OF THE INVENTION

A catalytic hydrocarbon fuel reformer converts oxygen and a fuel comprising, for example, natural gas, light distillates, methanol, propane, naphtha, kerosene, gasoline, diesel fuel, or combinations thereof, into a hydrogen-rich reformate stream comprising a gaseous blend of hydrogen, carbon monoxide, and nitrogen, plus trace components. In a typical reforming process, the hydrocarbon fuel is mixed with a gas containing oxygen (for example in the form of air and/or steam) and then passed through a catalyst bed or beds contained within one or more reactor tubes mounted in a reformer vessel. The catalytic conversion process is typically carried out at elevated catalyst temperatures in the range of about 700° C. to about 1000° C.

The produced hydrogen-rich reformate stream may be used, for example, as the fuel gas stream feeding the anode of an electrochemical fuel cell. Reformate is particularly well suited to fueling a solid-oxide fuel cell (SOFC) system because a purification step for removal of carbon monoxide is not required as in the case for a known proton exchange membrane (PEM) fuel cell systems.

The reformate stream may also be used to fuel a spark-ignited (SI) engine, either alone or in combination with gasoline or other suitable fuels. Hydrogen-fueled vehicles are of interest as low-emissions vehicles because hydrogen as a fuel or a fuel additive can significantly reduce air pollution and can be produced from a variety of fuels. Hydrogen permits an engine to run with very lean fuel-air mixtures that greatly reduce production of NOx. As a gasoline additive, small amounts of supplemental hydrogen fuel may allow conventional gasoline-fueled internal combustion engines to reach nearly zero emissions levels. Similarly, reformate may be used to partly fuel a compression ignition (Cl) engine in combination with diesel or other suitable fuels. In addition, reformate may be used advantageously as a reductant for lean NOx aftertreatment.

Fuel/air mixture preparation constitutes a key factor in the reforming quality of catalytic reformers, and also the performance of porous media combustors. A problem in the prior art has been how to vaporize liquid hydrocarbon fuels completely and uniformly, especially at start-up when the apparatus is cold. A related problem is that fuel droplets when injected into a mixing chamber at the entrance to a reformer may follow a line-of-sight path directly to the entry surface of the catalyst, resulting in extreme, localized fuel/air inhomogeneities. Inhomogeneous fuel/air mixtures can lead to decreased reforming efficiency and reduced catalyst durability through coke or soot formation on the catalyst and thermal degradation from local hot spots. Poor fuel vaporization can lead to fuel puddling, resulting in uncertainty in the stoichiometry of fuel mixture. Complete and rapid fuel vaporization well ahead of the catalyst is a key step to achieving a homogeneous gaseous fuel-air mixture at entry to the catalyst bed and consequent efficient reformate generation.

In the prior art, liquid fuel is mixed with pre-heated air in a mixing chamber to vaporize the fuel before reaching the catalyst. A challenge in the prior art is to raise the temperature of the fuel to the point where it is fully vaporized, but to not allow the fuel to self-ignite and combust in the carrier medium which, in the prior art, is oxygen-containing air.

Oxygen is often required in the reforming process, so air is a typical, inexpensive, easy choice for the fuel carrier medium. It is possible to vaporize and transport gasoline in air, but it requires careful control of temperature within a narrow range: too cool, and the fuel is not fully vaporized; too hot, and the mixture self-ignites. This situation is even worse with diesel fuels since there can be no temperature in the presence of air where some portion of the fuel does not fully vaporize and another portion of the fuel is not prone to self-ignite.

What is needed in the art is a method and means for combining injected liquid fuel with a hot carrier gas that causes complete vaporization of the fuel without risk of self-ignition of the resulting gaseous mixture.

It is a primary object of the invention to completely vaporize hydrocarbon fuel in the presence of a hot carrier gas ahead of a catalytic reformer without risk of self-ignition of the resulting gaseous mixture.

### SUMMARY OF THE INVENTION

In an aspect of the invention applicable to an integrated fuel cell system, a catalytic reformer assembly reforms gaseous hydrocarbon fuel such as diesel or jet fuel to generate reformate which fuels an energy source such as a solid oxide fuel cell (SOFC) assembly. The SOFC assembly emits a hot tail gas (syngas) from the anodes which contains significant residual hydrogen and carbon monoxide, is very hot, and has a low partial pressure of oxygen. It is known to recycle at least a portion of syngas into a reformer. Syngas is thus an ideal medium for vaporizing and carrying fuel into the reformer. A portion of the anode syngas being emitted by the SOFC assembly is recycled into a fuel vaporizer/mixer ahead of the reformer and ahead of the entry point of air into the feed stream, such that the fuel dispersed into the vaporizer/mixer is fully vaporized and heated prior to being combined with air for exothermic reforming or additional recycled gas for endothermic reforming. For the reforming of heavier fuels, a portion of between 40% and 95% of the total syngas emitted, for recycling, is preferred.

In another aspect of the invention applicable to a gasoline or diesel engine management system, the engine produces an exhaust gas which is much depleted in terms of free oxygen, especially when the engine is run at or near the stoichiometric condition. A small fraction of this engine exhaust gas, in the range of about 2% to about 20%, is preferably used to fully vaporize the fuel input to the reformer—prior to mixing with additional air.

In yet another aspect of the invention applicable to a syngas production process (for example as a step in the manufacture of hydrogen gas or Fischer Tropsch synthetic fuels) a fraction of the reformate itself of about 50% or less may be recycled into the inlet of the reformer and used to fully vaporize the liquid fuel.

In each exemplary application, the quantity and/or temperature of recycled gas used can be controlled so that the fuel is quickly and fully vaporized and the resulting is mixture is at a low enough temperature to avoid pre-reactions of the fuel molecules.

The fuel cell application is demonstrative of the novel fuel vaporization and reforming process and so is described in the following drawings.

### BRIEF DESCRIPTION OF THE DRAWINGS

The present invention will now be described, by way of example, with reference to the accompanying drawings, in which:

FIG. 1 is a schematic drawing of a first embodiment of a integrated fuel cell system in accordance with the invention; and

FIG. 2 is a schematic drawing of a second embodiment of a integrated fuel cell system in accordance with the invention.

### DESCRIPTION OF THE PREFERRED EMBODIMENT

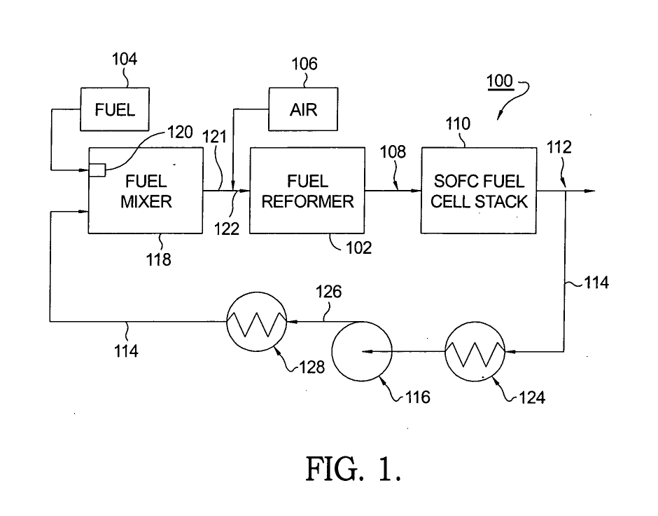

Referring to FIG. 1, a first embodiment 100 of an integrated fuel cell system in accordance with the invention includes a reformer assembly 102 for catalytically reforming hydrocarbon fuel 104 and oxygen in the form of air 106 to produce a hydrogen-rich reformate gas 108 which, in the example shown, is supplied to a solid oxide fuel cell stack 110. Stack 110 produces electricity in known fashion and exhausts anode tail gas (syngas) 112. A portion 114 of syngas 112 is diverted for recycle into reformer assembly 102 via syngas pump 116. The description of the invention thus far is well represented in the prior art.

The novelty of the present invention consists in providing a fuel vaporizer/mixer 118 ahead of reformer assembly 102 into which liquid fuel 104 is injected and dispersed by injector 120 and into which at least a portion of syngas 112 is controllably supplied as stream 114 via pump 116 as a carrier gas for fuel 104. Syngas portion 114 is at a temperature range of approximately 200°C. to 700° C. that is sufficient to cause virtually instantaneous vaporization of fuel 104 injected into the syngas, with no potential for self-ignition since there is no free oxygen in either the fuel or the syngas. A continuous stream of the hot mixture 121 of vaporized fuel and syngas passes from vaporizer/mixer 118 and is combined with air 106 to form a second gaseous mixture 122 suitable for reforming in reformer 102; additional syngas may be introduced at this point, as well, if desired for chemical balance. Any heat and combustion products generated in second mixture 122 by the sudden presence of oxygen is immediately introduced and subsequently used in reformer 102 to support the reforming process.

In a typical prior art process wherein syngas is recycled directly into the inlet of a reformer, syngas portion 114 is cooled by a heat exchanger like first heat exchanger 124 after stack 110 to facilitate pumping the gas stream. Low-temperature gas pumps are much less expensive and trouble-prone than known high-temperature gas pumps, and the heat extracted by heat exchanger 124 can be transferred, for example, to incoming air 106. Further, if desired the heat lost in heat exchanger 124 can be replaced in pump output 126 via a second heat exchanger 128 by plumbing the “hot” and “cold” sides of the two heat exchangers appropriately, for example by reverse cascade flow of syngas portion 114 first through the “hot” side of second heat exchanger 128 and then through the “hot” side of first heat exchanger 124 (flow path not shown).

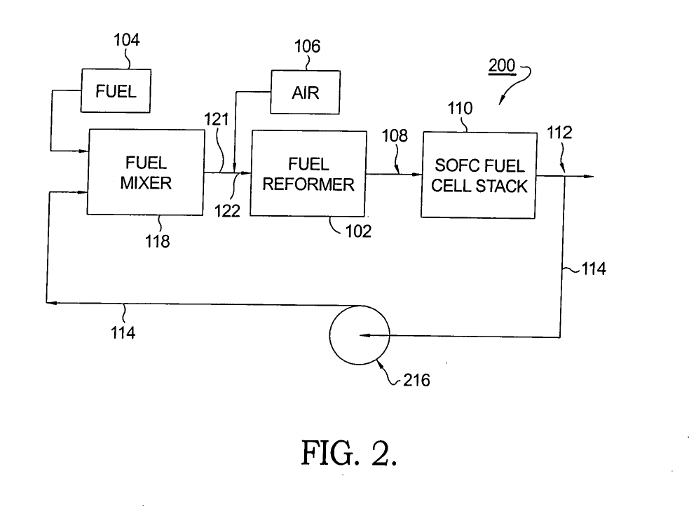

Referring now to FIG. 2, a second embodiment 200 of an integrated fuel cell system in accordance with the invention is substantially identical with first embodiment 100 except that the syngas recycle pump 216 is a high-temperature pump, obviating the need for the two heat exchangers 124, 126 and thus significantly simplifying the assembly 200.

While the invention has been described by reference to certain preferred embodiments, it should be understood that numerous changes may be made within the spirit and scope of the inventive concepts described. Accordingly, it is intended that the invention not be limited to the disclosed embodiments, but that it have the full scope permitted by the language of the following claims.

What is claimed is:

1. A method of reforming liquid fuels to produce reformate comprising:
a) metering of a fuel into a hot gas carrier, said hot gas carrier having a reduced partial pressure of oxygen relative to air;
b) vaporizing said fuel by dilution and heating with said hot gas carrier to produce a resulting gas mixture; and
c) mixing said gas mixture with a second gas containing oxidants required for the reforming process.

2. A method of reforming liquid fuels in accordance with claim 1 including the step of controlling at least one of a temperature and quantity of said hot gas carrier prior to vaporizing the fuel to control a temperature of said gas mixture.

3. A method of reforming liquid fuels in accordance with claim 1 wherein a solid oxide fuel cell is fueled by at least a portion of said reformate and said hot gas carrier is a portion of a hot tail gas emitted from anodes of said solid oxide fuel cell.

4. A method of reforming liquid fuels in accordance with claim 3 wherein the hot tail gas used as the hot gas carrier is less than 95% of the hot tail gas emitted from the anodes of the solid oxide fuel cell.

5. A method of reforming liquid fuels in accordance with claim 3 wherein the portion of hot tail gas used as the hot gas carrier is less than 60% of the hot tail gas emitted from the anodes of the solid oxide fuel cell.

6. A method of reforming liquid fuels in accordance with claim 3 wherein the portion of hot tail gas used as the hot gas carrier is less than 40% of the hot tail gas emitted from the anodes of the solid oxide fuel cell.

7. A method of reforming liquid fuels in accordance with claim 1 wherein an internal combustion engine is fueled, at least in part, by said reformate and said hot gas carrier is a portion of an exhaust emitted from the internal combustion engine.

8. A method of reforming liquid fuels in accordance with claim 7 wherein the portion of exhaust used as the hot gas carrier is less than 20% of the exhaust emitted from the internal combustion engine.

9. A method of reforming liquid fuels in accordance with claim 7 wherein the portion of exhaust used as the hot gas carrier is less than 5% of the exhaust emitted from the internal combustion engine.

10. A method of reforming liquid fuels in accordance with claim 7 wherein the portion of exhaust used as the hot gas carrier is less than 2% of the exhaust emitted from the internal combustion engine.

11. A method of reforming liquid fuels in accordance with claim 1 wherein said reformate is produced by a reformer and said reformer receives at least a portion of said reformate as said hot gas carrier.

12. A method of reforming liquid fuels in accordance with claim 11 wherein said hot gas carrier comprises less than about 50% of the reformate produced by said reformer.

13. An integrated system for producing energy, comprising:
a) a catalytic hydrocarbon reformer for generating reformate;
b) an energy producing source for oxidizing components of said reformate to produce said energy and a stream of hot gas having a reduced partial pressure of oxygen relative to air;
c) a fuel vaporizer/mixer for receiving at least a portion of said stream of hot gas and a stream of liquid hydrocarbon fuel, wherein said liquid hydrocarbon fuel is vaporized by exposure to said at least a portion of said hot gas and becomes mixed therewith to form a gaseous mixture for being mixed with air to supply said catalytic hydrocarbon reformer.

14. An integrated system in accordance with claim 13, wherein said energy producing source is a solid oxide fuel cell and said stream of hot gas is at least a portion of a hot tail gas emitted from anodes of said solid oxide fuel cell.

15. An integrated system in accordance with claim 13, wherein said energy producing source is an internal combustion engine and said stream of hot gas is at least a portion of a hot exhaust emitted from said internal combustion engine.

16. An integrated system in accordance with claim 13 further comprising a pump for delivering said at least a portion of said stream of hot gas to said fuel vaporizer/mixer.

17. An integrated system in accordance with claim 16 wherein said pump is a high-temperature pump capable of performing such delivery at a temperature of said hot gas emitting from energy producing source.

18. An integrated system in accordance with claim 16 wherein said system further comprises a heat exchanger disposed between said energy producing source and said pump for reducing the temperature of said at least a portion of said hot gas stream entering said pump.

19. An integrated system in accordance with claim 18 further comprising a second heat exchanger disposed between said pump and said fuel vaporizer/mixer for reheating said at least a portion of said stream of hot gas.

20. A method for vaporizing liquid hydrocarbon fuel being supplied to a catalytic hydrocarbon reformer comprising:
a) metering of a fuel into a hot gas which has a reduced partial pressure of oxygen relative to air;
b) vaporizing said fuel by dilution and heating with said hot gas to produce a resulting gas mixture; and
c) mixing the gas mixture with a second gas containing oxidants required for the reforming process.

21. A method for vaporizing liquid hydrocarbon fuel being supplied to a catalytic hydrocarbon reformer in accordance with claim 20 including the step of controlling at least one of a temperature and quantity of said hot gas prior to vaporizing the fuel to control a temperature of said gas mixture.

22. A method for vaporizing liquid hydrocarbon fuel being supplied to a catalytic hydrocarbon reformer in a fuel cell system including a solid oxide fuel cell stack for generating a stream of anode tail gas, the method comprising the steps of:
a) providing a fuel vaporizer/mixer in communication with said catalytic hydrocarbon reformer;
b) recycling at least a portion of said stream of anode tail gas through said fuel vaporizer/mixer into said catalytic hydrocarbon reformer;
c) dispersing fuel into said at least a portion of said stream of anode tail gas while passing through said fuel vaporizer/mixer; and
d) vaporizing said dispersed fuel by contact with said at least a portion of said stream of anode tail gas passing through said fuel vaporizer/mixer.
